(19) United States
(12) Patent Application Publication
(10) Pub. No.: US 2022/0027111 A1
(43) Pub. Date: Jan. 27, 2022

(54) ADJUSTING CAMERA OPERATION FOR ENCODED IMAGES

(71) Applicant: Hewlett-Packard Development Company, L.P., Spring, TX (US)

(72) Inventors: Xueling Lu, Alpharetta, GA (US); Nathan Shirley, Vancouver, WA (US); Edward Filby, London (GB); Matt Smith, London (GB); Alex Name, London (GB); David R. Parry, Corvallis, OR (US)

(73) Assignee: Hewlett-Packard Development Company, L.P., Spring, TX (US)

(21) Appl. No.: 17/311,461

(22) PCT Filed: Apr. 18, 2019
(86) PCT No.: PCT/US2019/028199

§ 371 Date: Jun. 7, 2021

(51) Int. Cl. G06F 3/12; G06K 7/14; G06K 9/20

(52) U.S. Cl. CPC G06F 3/1292; G06K 7/1408; G06K 9/2063; G06K 7/1465

(57) ABSTRACT

Examples provide for a mobile computing device to include a camera, a processor and a memory resource to store a printing control application. In examples, the processor can execute the printing device control application to control the camera to capture a series of images of a region surrounding the mobile computing device using a plurality of image setting. Additionally, the processor can process individual images of the series of images using a corresponding image setting of the plurality of image settings and detect, by processing the individual images, a graphical encoding element in at least a first image of the series of images, using the corresponding image setting of the at least first image. Upon the processor detecting the graphical encoding element, the processor can perform operations to implement an encoding recognition state to interpret an encoding of the detected graphical encoding element.

### BACKGROUND

Digital cameras have a variety of uses, above and beyond image capture. For example, mobile devices can run applications that use the device's camera to scan documents, take measurements, and perform authentication. In retail centers, users can use their mobile devices to scan product codes (e.g., barcodes) to view information about a product at an online site. Mobile devices can also run camera applications to alter imagery with overlay content, manipulating image data within the image itself (e.g., making funny faces from images) or augmenting the content of captures images (e.g., replacing faces of people on captures images).

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates an example mobile computing device that can perform operations to operate in an encoding recognition state;

FIG. 2 illustrates another example of a mobile computing device that can perform operations to operate in an encoding recognition state;

FIG. 3 illustrates an example method for adjusting image settings to enable a mobile computing device to operate in an encoding recognition state; and

FIG. 4 illustrates an example method for determining whether a detected graphical encoding element of a captured image meets a sufficiency threshold for the purpose of interpreting an encoding of the detected graphical encoding element.

Throughout the drawings, identical reference numbers designate similar, but not necessarily identical elements. The figures are not necessarily to scale, and the size of some parts may be exaggerated to more clearly illustrate the example shown. Moreover, the drawings provide examples and/or implementations consistent with the description. However, the description is not limited to the examples and/or implementations provided in the drawings.

### DETAILED DESCRIPTION

Examples provide for a camera-equipped mobile computing device to control the camera to capture a series of images of a region surrounding the mobile computing device. In such examples, the mobile computing device can use a plurality of image settings when the camera captures the series of images. The mobile computing device can process individual images of the series of captured images using a corresponding image setting of the plurality of image settings. Additionally, the mobile computing device can detect the graphical encoding element by processing the series of captured images and using the corresponding image setting. Upon detecting the graphical encoding element, the mobile computing device can perform operations to implement an encoding recognition state to interpret an encoding of the detected graphical encoding element.

As herein described, a graphical encoding element can be aesthetic in nature. Additionally, the graphical encoding element can also be part of an aesthetic design feature of a device, such as a printing device.

Among other benefits, examples enhance the operation of camera-equipped mobile computing devices when such mobile computing devices are used to detect and interpret graphical encoding elements that may be in image data. In particular, some examples reduce the reaction time of such mobile computing devices when the cameras of such mobile computing devices are used to detect, recognize and interpret these graphical encoding elements on surfaces of objects, including encoded surfaces that provide graphic design features that are aesthetic in nature and integrated or unitarily formed on a surface of a device (e.g., a printing device).

Examples described herein provide that methods, techniques, and actions performed by a mobile computing device are performed programmatically, or as a computer-implemented method. Programmatically, as used, means through the use of code or computer-executable instructions. These instructions can be stored in a memory resource of the mobile computing device. A programmatically performed step may or may not be automatic.

Additionally, examples described herein can be implemented using programmatic modules, engines, or components. A programmatic module, engine, or component can include a program, a sub-routine, a portion of a program, or a software component or a hardware component capable of performing stated tasks or functions. As used herein, a module or component can exist on a hardware component independently of other modules or components. Alternatively, a module or component can be a shared element or process of other modules, programs, or machines.

Moreover, examples described herein can utilize specialized mobile computing devices, including processing and memory resources. For example, examples described may be implemented, in whole or in part, on mobile computing devices such as servers, desktop computers, cellular or smartphones, personal digital assistants (e.g., PDAs), laptop computers, printers, digital picture frames, network equipment (e.g., routers), wearable mobile computing devices, and tablet devices. Memory, processing, and network resources may all be used in connection with the establishment, use, or performance of any example described herein (including with the performance of any method or with the implementation of any system). For instance, a mobile computing device coupled to a data storage device storing the computer program and to execute the program corresponds to a special-purpose mobile computing device. Furthermore, any computing systems referred to in the specification may include a single processor or may be architectures employing multiple processor designs for increased computing capability.

Furthermore, examples described herein may be implemented through the use of instructions that are executable by a processor. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums.

Additionally, examples may be implemented in the form of computer-programs, or a computer usable carrier medium capable of carrying such a program.

### System Description

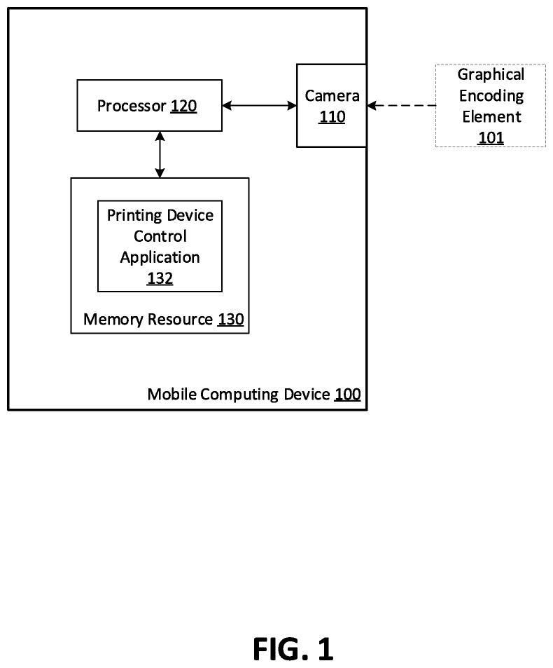

FIG. 1 illustrates an example mobile computing device that can perform operations to operate in an encoding recognition state to adjust camera operations for encoded images. In examples, a mobile computing device 100 can correspond to, for example, a camera-capable telephonic device (e.g., feature or smart phone), tablet device, laptop or notebook, or wearable device. The mobile computing device 100 includes a camera 110, a processor 120 and a memory resource 130 that stores a printing device control application 132 that is executable by the processor 120. The camera 110 can operate to capture images or a series of images (e.g., an object with graphical encoding element 101), and the processor 120 can process corresponding image data to perform operations that include detecting graphical encoding elements in the captured images and interpreting the recognized graphical encoding elements depicted in the captured images.

In examples, the processor 120 can execute the printing device control application 132 stored in memory resource 130 to control the camera 110 to capture a series of images in the surrounding region of the mobile computing device. In such examples, the processor 120 can utilize a plurality of image settings when controlling the camera 110 to capture the series of images. In some examples, the surrounding region of mobile computing device 100 can include an object with graphical encoding element 101. The processor 120 can execute printing device control application 132 to capture a series of images of the object with graphical encoding element 101 using a plurality of image settings. As herein described, the image settings of mobile computing device 200 can include image capture settings of camera 210 (e.g., resolution settings, zoom/focus level settings, and contrast settings), and image processing settings that processor 220 may utilize for processing captured images (e.g., resolution settings and contrast settings).

In various examples, the processor 120 can process each individual image of the series of captured images to determine or detect the presence of a graphical encoding element (e.g., graphical encoding element 101) in at least one image of the series of captured images. In such examples, processor 120 can utilize the same image setting or settings used when capturing the images, to process or analyze the image for the presence of the graphical encoding element.

Upon the processor 120 detecting a graphical element in at least an image of the series of captured images, the processor 120 can perform operations to implement an encoding recognition state to interpret an encoding of the detected graphical encoding element. The processor 220 can be said to be operating in n encoding recognition state when the processor 220 can detect and interpret a graphical encoding element in a captured image. In some examples, although processor 120 may have detected the presence of a graphical encoding element (e.g., graphical encoding element 101), processor 120 may not be able to recognize, let alone, interpret the encoding of the detected graphical encoding element. As such, the processor 120 can perform various operations, such as, adjusting an image setting, to enable the mobile computing device 100 to be in an encoding recognition state.

In variations, an encoding provided by graphical encoding elements, such as graphical encoding element 101, can be subtle, so as to be part of, for example, a cohesive aesthetic image or feature. By way of examples, the graphical encoding elements can correspond to speckles, polygon shapes or other aesthetically appealing graphical elements that overlay, or otherwise appear in in the foreground of background imagery, where the background imagery can provide, for example, a color scheme, theme and/or image. Accordingly, the graphical encoding elements can form a part of a larger graphical design feature or image. Such graphical encoding elements can further serve dual purposes, one being aesthetic to accentuate, for example, an appearance of a graphical design feature or image, and the other being functional, to convey instructions or values in accordance with a predetermined encoding scheme.

In some implementations, the graphical encoding elements appear in a graphical design feature that is integrated, or otherwise unitarily formed with the surface or structure of another device. Some objects, for example, may include an exterior façade on which such graphical design feature is provided. Such objects may be referred to as encoded objects, for purposes of examples described herein.

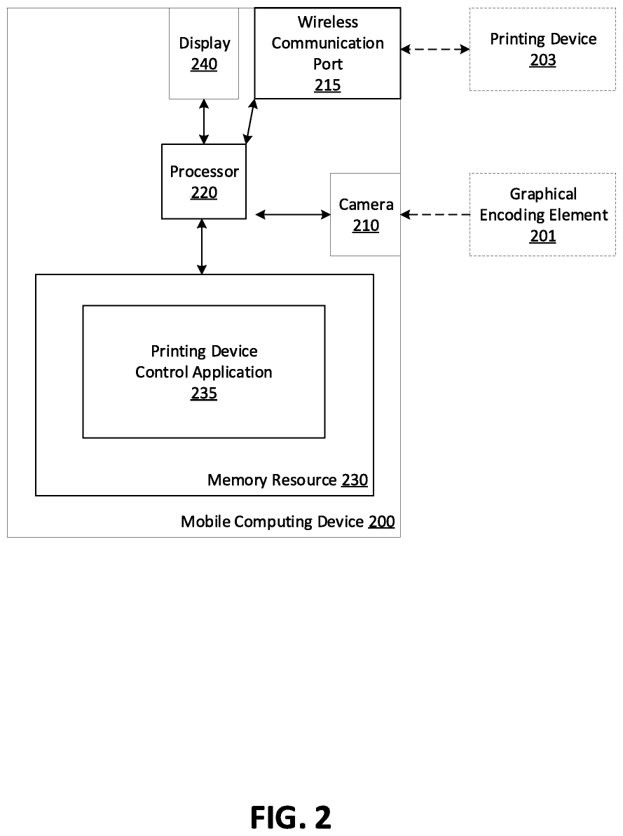

FIG. 2 illustrates another example of a mobile computing device that can perform operations to operate in an encoding recognition state. As with an example of FIG. 1, a mobile computing device 200 can also correspond to, for example, a camera-equipped feature phone or tablet device, laptop or notebook, wearable device or another camera capable device.

The mobile computing device 200 includes a camera 210, a processor 220 and a memory 330 that stores printing device control application 235 executable by the processor 220. The camera 210 can operate to capture images or a series of images, and the processor 220 can process corresponding image data of the captured images to perform operations that include detecting, recognizing and interpreting graphical encoding elements (e.g., graphical encoding element 201 of an object) depicted in the captured images. The processor 220 can access the printing device control application 235 from the memory resource 230 to detect, recognize and interpret graphical encoding elements of an encoded object or surface. The processor 220 can interpret the encoding of the detected graphical encoding elements by determining the encoding values or instruct of the encoding.

As described with various examples, the camera 210 can operate to capture images of an encoded object or surface, where the encoded object or surface includes a graphic design feature that is both aesthetic and encoded. The encoding of the graphic design feature can further be implemented through use of graphical encoding elements (e.g., graphical encoding element 201), which individually or collectively, include visually detectable features that are interpretable as a value or instruct, in accordance with a predefined encoding scheme. In examples, the processor 220 can execute the printing device control application 235 to detect a set of predefined visual features on an encoded surface or object. In such examples, the encoded surface or object can be a device, such as printing device 203, that includes an exterior facade on which a graphical design feature is integrated or unitarily formed, where the graphic design feature is encoded to include multiple graphical encoding elements. The graphic design feature may be aesthetic in nature. Moreover, the graphical encoding elements may also be aesthetic, such that, for example, the graphical encoding elements are visually cohesive and appealing when viewed as part of the graphic design feature.

Examples as described recognize that the rendered image of the scene can be out-of-focus, at least with respect to the encoded object or surface, such that the processor 220 cannot detect or interpret the graphical encoding elements. In some cases, for example, the camera 210 may operate to focus on an encoded object or surface in the surrounding region of mobile computing device 200 other than the encoded object or surface. Still further, in other variations, the processor 220 may utilize native auto-focus processes for camera 210 that may require additional time when the focus of the image is of a pattern or graphical design feature. For example, the native auto-focus processes that the processor 220 utilizes for camera 210 may not enable the camera 210 to capture an image with a graphical encoding element that the processor 220 can detect, at least by default. As another example, processor 220 may not recognize details of an encoded surface or object as being an area of interest in an image captured by camera 210. Examples as described overcome delays and inefficiencies that can result from such scenarios, by quickly and efficiently controlling the image settings of mobile computing device 200 to enable an encoding recognition state, where the operational values that define the image settings are suitable to enable the image data of an encoded object or surface to be analyzed, for purpose of detecting and interpreting graphical encoding elements. As herein described, the image settings of mobile computing device 200 can include image capture settings of camera 210 (e.g., resolution settings, zoom/focus level settings, and contrast settings), and image processing settings that processor 220 may utilize for processing captured images (e.g., resolution settings and contrast settings).

In examples, processor 220 can execute a printing device control application 235 to control the camera 210 to capture images or a series of images of encoded objects or surfaces on which a graphical encoding element 201 is provided, where the graphical design feature or element is both aesthetic and functional. The processor 220 can operate to automatically adjust image settings of the camera 210, to optimize the operation of the camera 210 for the purpose of the processor 220 to detect and interpret graphical encoding element 201 of an object or surface in the viewing angle of the camera 210. When the mobile computing device 200 is operated with image settings that are optimized for the mobile computing device 200 to detect an interpret graphical encoding elements in a captured image, the mobile computing device 200 can be said to operate in an encoding recognition state. In some examples, the processor 220 can take into account various conditions when determining adjustments to the image settings. Examples of such conditions include a lighting condition, a viewing angle of the surface or encoded object, and/or a resolution or proximity of the encoded object or surface.

In various examples, the processor 220 can execute a printing device control application 235 to detect the presence of a graphical encoding element (e.g., graphical encoding element 201) of an object or surface, for the purpose of determining an encoded value or instruct from the encoding of the graphical encoding element. In executing the printing device control application 235, the processor may utilize a predefined encoding scheme stored in the memory resource 230 to detect the presence of the graphical encoding element. For example, the processor 220 can execute the printing device control application 235 to control camera 210 to capture a series of images of a region surrounding the mobile computing device 200. The series of captured images may include an object with a graphical encoded element on the surface of the object. As such, the processor 220 can determine or detect the presence of a graphical encoded element in at least one of the series of captured images by processing the captured series of images.

In some examples, the processor 220 can detect the graphical encoding element in one of the images of the series of captured images. In such examples, the processor 220 can detect the graphical encoding element in a captured image by processing the series of captured images and using image settings that were utilized in capturing and processing the series of captured images. For example, the processor 220 can execute printing device control application 235 to capture an image using a particular zoom level setting. The processor 220 can also process the captured image using the same particular zoom level setting that the processor 220 used, when capturing the image. Additionally, the processor 220 can detect the graphical encoding element in the captured image by processing and using the image setting used to capture and process the captured image.

Upon processor 220 detecting the presence of graphical encoding element 201 in at least one of the images of the series of captured images, the processor 220 can execute printing device control application 235 to perform operations for implementing an encoding recognition state to interpret an encoding of the detected graphical encoding element. Examples herein recognize that, even though processor 220 may detect the presence of graphical encoding element 201 in at least one of images of the series of captured images, the processor 220 may not be able to interpret the detected graphical encoding element. In examples, the processor may interpret the detected graphical encoding element by determining an encoding/encoded value or instruct from the encoding of the detected graphical encoding element.

In some examples, processor 220 may perform operations to determine whether the detected graphical encoding element (e.g., graphical encoding element 201) is recognizable enough for the processor 220 to interpret the encoding of the detected graphical encoding element. For example, the processor 220 may determine that the detected graphical encoding element is recognizable for interpretation, based on whether an aspect of the image data of the captured image with the detected graphical encoding elements, meets a minimum threshold of sufficiency for the purpose of interpreting the graphical encoding elements. In such an example, the minimum threshold of sufficiency (e.g., a predetermined threshold count) may be based on, for example, parameters of the predefined encoding scheme. For instance, the processor 220 may determine a captured image includes a number of detected graphical encoding elements, based on the image data of the captured image. Additionally, processor 220 may determine that number of detected graphical encoding elements of the captured image meets a predetermined threshold count. The processor 220 may then determine that the detected graphical encoding elements are recognizable for interpretation based on the determination of whether the number of detected graphical encoding elements met the predetermined threshold count.

The number or count of detected graphical encoding elements may be impacted by image settings the processor 220 may have implemented when causing camera 210 to capture the images and/or processing the captured images. The processor 220 may implement the adjustments to the image settings in response to determining the number or count of detected graphical encoding elements is insufficient (or less than the threshold) for purpose of determining an encoded value or instruct. For example, the processor 220 may determine that a number of detected graphical encoding elements of a captured image may not meet a predetermined threshold count. In response to such a determination, the processor 220 executing the printing device control application 235, can automatically adjust image settings (e.g., contrast settings and/or resolution settings) for processing a next image for the purposes of determining whether the next image satisfies the predetermined threshold count. The next image can be another image that the camera 210 captures, or another image in the series of captured images that has yet to be processed. In an example, the processor 220 can utilize the adjusted image settings (e.g., adjusted contrast settings) to determine the number of detected graphical encoding elements detected in the next image. Additionally, the processor 220 can determine whether the determined number of detected graphical encoding elements meets the predetermined threshold count. The processor 220 may then determine whether the detected graphical encoding elements in the next image are recognizable for interpretation based on the determination of whether the number of detected graphical encoding elements meet the predetermined threshold count.

In examples, the processor 220 can execute printing device control application 235 to adjust one or multiple image settings to meet a minimum threshold level of sufficiency for the purpose of interpreting the graphical encoding elements. To meet the threshold level, the processor 220 can execute the printing device control application 235 to adjust, for example, image capture settings of camera 210 and/or image processing settings that processor 220 may utilize for processing captured images. For example, based on the determination that the number of detected graphical encoding elements of a captured image does not meet a predetermined threshold count, the processor 220 can execute the printing device control application 235 to adjust the resolution setting (of the camera 210 or that the processor 220 may utilize for processing the captured images), recognizing that higher resolution images may, at a given magnification, increase the number of detected graphical encoding elements. As an addition or alternative, the processor 220 can execute the printing device control application 235 to adjust the contrast value setting (of the camera 210 or that the processor 220 may utilize for processing the captured images), recognizing that a setting to capture higher contrast images can also increase the number of detected graphical encoding elements. As another addition or alternative, the processor 220 can execute the printing device control application 235 to adjust the magnification setting of the camera 210, recognizing that lower magnification can increase the number of graphical encoding elements that can be detected when close proximity is at issue, while higher magnification can also increase the number of graphical encoding elements that can be detected when distance is at issue.

In some examples, the processor 220 can repeatedly perform adjustment operations (e.g., operations for adjusting the image settings) and sufficiency determination operations (e.g., operations to determine whether an aspect of the image data of the captured images with the detected graphical encoding elements meets a minimum threshold of sufficiency) until a threshold number of iterations is reached. Additionally, or alternatively, the processor 220 can repeatedly perform the sufficiency determination operations and adjustment operations until the minimum threshold of sufficiency for the purpose of interpreting the graphical encoding elements is met (e.g., the number of graphical encoding elements that are depicted in a captured image meets a predetermined threshold count).

In various examples, the processor 220 executes the printing device control application 235 to perform operations for implementing an encoding recognition state to interpret an encoding of the detected graphical encoding element, in response to detecting a user input. For example, mobile computing device 200 can include a display 240. The processor 220, can execute the printing device control application 235 to detect a user input corresponding to a user touching the display 240. Additionally, the processor 220 can determine that the user input indicates a portion of an image to be processed. As such, the processor 220 can recognize the user touching the display as a trigger for performing operations, such as automatically adjusting the image setting (e.g., magnification settings) for processing an image on the portion of the image that is indicated by the user input.

In examples, the processor 220 can take into various conditions when performing the operations to implement an encoding recognition state. Examples of such conditions include, lighting conditions of when the series of images are captured by camera 210, proximity of the detected graphical encoding elements, the viewing angle of the camera 210 with respect to the detected graphical encoding elements, and/or the size of the graphical encoding elements.

In various examples, the processor 220 can take into account the resources of mobile computing device 200 when performing adjustment operations. For example, the processor 220 can take into account the available resources of mobile computing device 200 when adjusting the resolution settings of the camera 210 as to not cause the camera 210 to clip when capturing an image.

Upon the processor 220 executing the printing device control application 235 recognizing the encoding of detected graphical encoding elements of a captured image, the processor 220 can perform operations based on interpretations or determined encoding values or instruct of the encoding of the detected graphical encoding elements. For example, the processor 220 can execute the printing device control application 235 to determine the encoding values or instructs of the encodings of the detected graphical encoding elements. Additionally, the processor 220 can determine that the encoding values or instructs correspond to an identifier of a device, such as printing device 203. In such examples, the processor 220 can execute the printing device control application 235 to obtain content associated with the printing device 203, such as captured images stored in memory resource 230 or on a separate database, to be printed using printing device 203. The content can be displayed on display 240 to indicate content to be printed and/or content already printed using printing device 203. Additionally, or alternatively, the processor 220 can execute the printing device control application 235 to communicate (e.g., wirelessly) with a particular printing device, such as printing device 203, based on the identifier. That way, the processor 220 can execute the printing device control application 235 to communicate and print content using the printing device 203.

In some examples, where the detected graphical encoding elements are from surfaces of an encoded object or surface. In such examples, the processor 220 can determine that the encoding values or instructs correspond to an application or sub-routine that the processor 220 executes to incorporate the encoded object in an augmented reality, using content determined from image data of the captured images. Accordingly, in examples, the processor 220 can generate augmented reality content for the display 240, by implementing an instruct or value of the encoded surface or object.

### Methodology

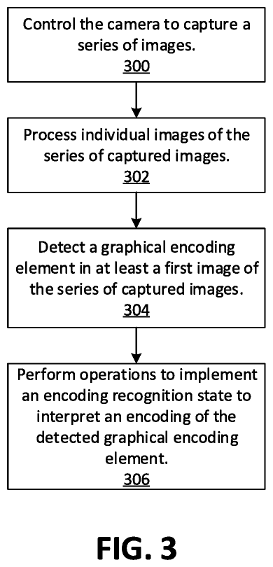

FIG. 3 illustrates an example method for adjusting image settings to enable a mobile computing device to operate in an encoding recognition state. In describing an example method of FIG. 3 reference may be made to elements of FIG. 2, for purpose of illustrating a suitable component or element for performing an example method being described.

In some examples, a processor 220 of mobile computing device 200 can execute a printing device control application 235 to control a camera 210 to capture a series of images (300). For example, processor 220 can control the camera 210 to capture the series of images of a region surrounding the mobile computing device using a plurality of image settings. The surrounding region of mobile computing device 200 can include an object with graphical encoding element 201. Additionally, as herein described, the image settings of mobile computing device 200 can include image capture settings of camera 210 (e.g., resolution settings, zoom/focus level settings, and contrast settings), and image processing settings that processor 220 may utilize for processing captured images (e.g., resolution settings and contrast settings).

In examples, the processor 220 can process individual images of the series of captured images (302). In some examples, the processor 220 can use the image settings that were used when the camera 210 captured the series of images when processing the individual images of the series of captured images. For example, the processor 220 can execute printing device control application 235 to capture an image using a particular resolution setting. Additionally, processor 220 can also process the captured image using the same particular resolution level setting that the processor 220 used when capturing the image.

In examples, a processor 220 can execute a printing device control application 235 to detect a graphical encoding element in at least a first image of the series of images 304. The processor 220 can execute the printing device control application 235 to detect the presence of the graphical encoding element for the purpose of determining an encoded value or instruct from the encoding of the graphical encoding element. In some examples, the processor 220 can detect a graphical encoding element in at least a first image of the series of images by processing the individual images and using the image settings that were utilized in capturing and processing the series of captured images.

In examples, the processor 220 can perform operations to implement an encoding recognition state to interpret an encoding of the detected graphical encoding element (306). In some examples, the processor 220 can perform the operations upon the processor 220 detecting the graphical encoding element in at least one of the captured images. In such examples, the processor 220 may not be able to recognize or interpret the encoding of the detected graphical encoding element. As such, the processor 220 may perform various operations, such as, adjusting an image setting, to enable the mobile computing device 200 to be in an encoding recognition state. The mobile computing device 200 can be said to operate in an encoding recognition state, when its image settings are optimized for encoding recognition.

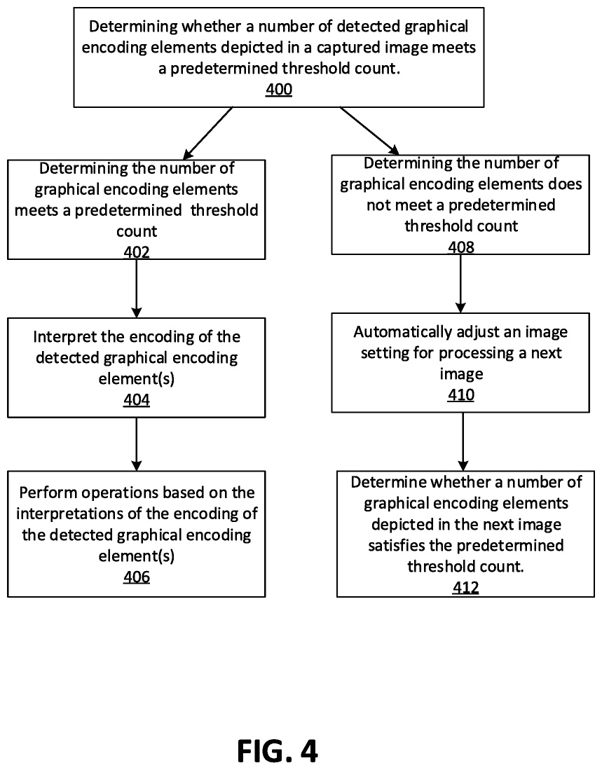

In various examples, a processor 220 may perform operations to determine whether an aspect of the image data of the series of captured images with the detected graphical encoding elements meets a minimum threshold of sufficiency for the purpose of interpreting the encoding of the detected graphical encoding element. FIG. 4 illustrates an example method for determining whether a detected graphical encoding element of a captured image meets a sufficiency threshold for the purpose of interpreting the encoding of the detected graphical encoding element. In describing an example method of FIG. 4, reference may be made to elements of FIG. 2, for purpose of illustrating a suitable component or element for performing an example method being described.

In examples, the processor 220 can execute the printing device control application 235 to determine whether a number of detected graphical encoding elements depicted in a captured image meets a predetermined threshold count (400). In such examples, the processor 220 has detected the presence of a graphical encoding element in the captured image. Additionally, the processor 220 can determine whether the captured image with the detected graphical encoding element meets a sufficiency threshold, such as the predetermined threshold count. In some examples, the processor 220 can further process the captured image to determine the presence of other graphical encoding elements in the captured image with the detected graphical encoding element. In examples, the processor 220 can execute the printing device control application 235 to process the captured images for determining the presence of other graphical encoding elements by using the same image settings as when the captured image was captured by camera 210. Additionally, the processor 220 can determine the total number of detected graphical elements in the captured image and determine whether the determined number of detected graphical elements in the captured image meets the predetermined threshold count.

In some examples, if the processor 220 determines the number of the graphical encoding elements does meet a predetermined threshold count (402), the processor 220 can interpret the encoding of the detected graphical encoding elements (404). In such examples, the processor 220 can interpret the encoding of the detected graphical encoding elements of the captured image by determining the encoding values or instruct of the encoding.

Additionally, the processor 220 can perform operations based on the interpretations of the encoding of the detected graphical encoding elements (406). For example, the processor 220 can determine that the encoding values or instructs correspond to an identifier of a device, such as printing device 203. Additionally, the processor 220 can obtain content, either from memory resource 230 and/or from a separate database, that is associated with the device, such as the printing device 203. The processor 220 can present the content on the display 240 of the mobile computing device 200. In examples, where the device of the identifier is a printing device 203, the processor 220, can execute the printing device control application 235 to communicate (e.g., wirelessly) with the printing device 203, based on the identifier. Additionally, in such examples, the processor 220 can print content with the printing device 203, by such communications with the printing device 203.

In other examples, if the processor 220 determines the number of the graphical encoding elements does not meet a predetermined threshold count (408), the processor can automatically adjust an image setting for processing a next image (410). For example, the processor 220 can execute the printing device control application 235 to process the captured image with the detected graphical encoding element to determine other graphical encoding elements by using the same image settings as when the image was captured by camera 210. Upon the processor 220 determining that the number of graphical encoding elements of the captured image does not meet the threshold count, the processor 220 can execute the printing device control application 235 to adjust an image setting for processing a next image. The next image can be another image that the camera 210 captures, or another image in the series of captured images that has yet to be processed. In such examples, the image settings of mobile computing device 200 can include image capture settings of camera 210 (e.g., resolution settings, zoom/focus level settings, and contrast settings), and image processing settings that processor 220 may utilize for processing captured images (e.g., resolution settings and contrast settings).

Additionally, the processor 220 can then determine whether the number of graphical encoding elements depicted in the next image satisfies the threshold count (412). If the processor 220 determines that the number of graphical elements depicted in the next image does not satisfy the threshold count, the processor 220 can repeatedly perform adjustment operations (e.g., operations for adjusting the image settings) and sufficiency determination operations (e.g., operations to determine whether an aspect of the image data of the captured images with the detected graphical encoding elements meets a minimum threshold of sufficiency) until the minimum threshold of sufficiency for the purpose of interpreting the graphical encoding element is met (e.g., the number of graphical encoding elements that are depicted in an image meets a predetermined threshold count). Additionally, or alternatively, the processor 220 can perform the adjustment operations and sufficiency determination operations until a threshold number of iterations is reached.

If the processor 220 determines that the number of graphical encoding elements depicted in the next image satisfies the threshold count, the processor 220 can then perform operations based on interpretations or determined encoding values or instruct of the encoding (e.g., determine an identifier of a device, such as a printing device, wirelessly communicate with the device based on the determined identifier, and/or obtain and present content associated with the device, based on the determined identifier).

Although specific examples have been illustrated and described herein, it will be appreciated by those of ordinary skill in the art that a variety of alternate and/or equivalent implementations may be substituted for the specific examples shown and described without departing from the scope of the disclosure. This application is intended to cover any adaptations or variations of the specific examples discussed herein.

What is claimed is:

1. A mobile computing device comprising:
a camera;
a processor; and
a memory resource to store a printing device control application;
wherein the processor is operable to execute the printing device control application to:
control the camera to capture a series of images of a region surrounding the mobile computing device using a plurality of image settings;
process individual images of the series of images using a corresponding image setting of the plurality of image settings;
detect, by processing the individual images, a graphical encoding element in at least a first image of the series of images, using the corresponding image setting of the at least first image; and
upon the graphical encoding element in the at least first image being detected, perform one or more operations to implement an encoding recognition state to interpret an encoding of the detected graphical encoding element.

2. The mobile computing device of claim 1, wherein the processor performs the one or more operations by:
making a determination as to whether the at least first image satisfies a threshold for recognizing the encoding of the detected graphical encoding element in the at least first image.

3. The mobile computing device of claim 2, wherein the processor makes the determination by determining whether a number of graphical encoding elements that are depicted in the at least first image meets a threshold count.

4. The mobile computing device of claim 3, wherein in response to the processor makes the determination that the number of graphical encoding elements depicted in the at least first image does not meet the threshold count, (i) automatically adjusting the image setting for processing a next image, and (ii) making a second determination as to whether the next image satisfies the threshold for recognizing the encoding.

5. The mobile computing device of claim 3, wherein the processor performs the one or more operations in response to detecting a user input, and by automatically adjusting the image setting for processing the next image on a portion of the next image that is indicated by the user input.

6. The mobile computing device of claim 3, wherein the processor repeatedly performs the one or more operations until at least one of (i) a threshold number of iterations is reached, or (ii) the number of graphical encoding elements that are depicted in the next image meets the threshold count.

7. The mobile computing device of claim 2, wherein the processor is further operable to execute the printing device control application to:
upon determining the at least first image satisfies the threshold for recognizing the encoding the detected graphical encoding element in the at least first image, interpret the encoding of the detected graphical encoding element in the at least first image; and
based on the interpretation of the encoding of the detected graphical encoding element of the at least first image, determine an identifier of a printing device.

8. The mobile computing device of claim 7, wherein the processor is further operable to execute the printing device control application to:
obtain content associated with the printing device, based on the determined identifier of the printing device; and
generate augmented reality content on a display of the mobile computing device, based on the content.

9. The mobile computing device of claim 7, wherein the processor is further operable to execute the printing device control application to:
wirelessly communicate with the printing device, based at least on the determined identifier of the printing device.

10. The mobile computing device of claim 1, wherein the image setting includes an image capture setting of the camera.

11. The mobile computing device of claim 10, wherein the image capture setting of the camera includes a contrast setting, a resolution setting, and a zoom level setting.

12. The mobile computing device of claim 1, wherein the image setting includes an image processing setting for processing captured images.

13. The mobile computing device of claim 12, wherein the image processing setting of the camera includes a contrast setting and a resolution setting.

14. A non-transitory computer-readable medium storing instructions, that when executed by a processor, causes a mobile computing device to:
control a camera of the mobile computing device to capture a series of images of a region surrounding the mobile computing device using a plurality of image settings;
process individual images of the series of images using a corresponding image setting of the plurality of image settings;
detect, by processing the individual images, a graphical encoding element in at least a first image of the series of images, using the corresponding image setting of the at least first image; and
upon the graphical encoding element in the at least first image being detected, perform one or more operations to implement an encoding recognition state to interpret an encoding of the detected graphical encoding element.

15. A method for operating a camera-capable device, the method being implemented by one or more processors of the camera-capable device and comprising:
controlling a camera of the camera-capable device to capture a series of images of a region surrounding the camera-capable device using a plurality of image settings;
process individual images of the series of images using a corresponding image setting of the plurality of image settings;
detect, by processing the individual images, a graphical encoding element in at least a first image of the series of images, using the corresponding image setting of the at least first image; and
upon the graphical encoding element in the at least first image being detected, perform one or more operations to implement an encoding recognition state to interpret an encoding of the detected graphical encoding element.
